(19) United States
(12) Patent Application Publication
(10) Pub. No.: US 2007/0137489 A1
(43) Pub. Date: Jun. 21, 2007

(54) Air purifier having sterilizing function

(75) Inventor: Xiaohua Luo, Guangdong (CN)

Correspondence Address: FISH & RICHARDSON PC, P.O. BOX 1022, MINNEAPOLIS, MN, 55440-1022, US

(73) Assignee: GUANGDONG MIDEA ELECTRIC APPLIANCES CO., LTD.

(21) Appl. No.: 11/606,720

(22) Filed: Nov. 30, 2006

(30) Foreign Application Priority Data
Dec. 15, 2005 (CN) 200520120402.1

(51) Int. Cl. B01D 46/00

(52) U.S. Cl. 96/224; 55/472

(57) ABSTRACT

The invention provides an air purifier having sterilizing function, comprising a vertically standing main frame, a front cover provided with air outlets, a blower assembly installed inside the main frame, and a control panel provided on the main frame, wherein the main frame has air inlets, an inlet grille is provided at a position corresponding to the air inlets, and an outlet grille is provided at a position corresponding to the air outlets of the front cover, and wherein a sterilizing device is provided under the blower assembly.

### FIELD OF THE INVENTION

The present invention relates generally to a filtering-type air purifier and, more particularly, to an improved filtering-type air purifier having a vertically standing main frame and provided with an ultra-violet sterilizing device.

### BACKGROUND OF THE INVENTION

With the development of modem industries, air pollution becomes more and more serious. In order to provide people with a comfortable and clean indoor air circumstance for their living and working, air purifiers are now widely used. For example, Chinese patent application No. 01816082.4 discloses an air purifier including a housing supporting an air inlet, an air outlet, and an airflow passage interconnecting the air inlet and the air outlet. The airflow passage is defined by a filtration chamber positioned upstream from a blower chamber and includes a fan driven by a motor, for forcing air through the airflow passage from the air inlet to the air outlet. A pre-filter and a main filter are removably supported within the air filtration chamber for entrapping particulates having a size of 0.3 microns and greater. An ultraviolet light source is positioned within the light chamber and is positioned proximate the air outlet. An outlet grille is supported proximate the air outlet and provides for the passage of air while substantially preventing the passage of ultraviolet light. This air purifier provides an advantage that the air is filtered by the filters and, at the same time, is sterilized by ultra-violet (UV) light. The ultraviolet light source kills or sterilizes the airborne microorganisms which have not been entrained by the filters so they will not reproduce. However, this air purifier has disadvantages in that it is bulky, occupies a large space area during use, and is difficult to handle or move.

### SUMMARY OF THE INVENTION

An object of the present invention is to provide an improved air purifier having sterilizing function, which should be compact and easy to handle or move, and which can filter the dust substance in the air and kill the airborne bacteria and micro microorganisms at the same time.

The air purifier of the present invention comprises a vertically standing main frame, a front cover provided with air outlets, a blower assembly installed inside the main frame, and a control panel provided on the main frame, wherein the main frame has air inlets, an inlet grille is provided at a position corresponding to the air inlets, and an outlet grille is provided at a position corresponding to the air outlets of the front cover, and wherein a sterilizing device is provided under the blower assembly.

Preferably, the sterilizing device comprises an ultra-violet lamp emitting C-band ultra-violet light.

Preferably, the blower assembly comprises a double-shaft motor, a double-entry penetrate-flow type blower wheel mounted to each shaft of the motor, and an airflow passage member being fixedly mounted and surrounding each of the blower wheels.

Preferably, each blower wheel comprises a wheel body and blade means extending from the wheel body to the opposite axial ends of the blower wheel.

Preferably, the blower wheels are similar to each other in structure and each comprises a wheel mounting sleeve provided at the center of the wheel body and including a through hole, and each blower wheel is fixedly mounted to a corresponding shaft of the motor by means of its wheel mounting sleeve.

Preferably, the inlet grille is provided with a snap locking means at its top portion, the snap locking means comprises an elastically deflection portion and a snap protrusion formed on the middle part of the deflection portion, and the inlet grille is snap engage with the main frame by the snap protrusion.

Preferably, the deflection portion extends outwardly and is ended with a grasping portion, the grasping portion being pushed when detaching the inlet grille.

Preferably, the side of the main frame which fits with the inlet grille is formed with two filter receiving compartments each containing a filter assembly, and each of the filter assemblies comprises a pre-filter, a HEPA filter and an activated carbon filter.

Preferably, each of the filter receiving compartment comprises a holding grille which allows airflow to pass through, and sidewalls extending outwardly from the holding grille to form a filter receiving space for arranging a filter assembly, at least one of the sidewalls is formed with a notch for facilitating the detach of the filter assembly.

Preferably, the main frame comprises a handle portion.

According to the present invention, the main frame has a vertically standing structure, and the sterilizing device is properly arranged inside the main frame. As a result, the whole air purifier is compact and occupies a relatively small area when using, and a user can handle or move the air purifier easily. The air purifier of the present invention, on the one hand, for the purpose of cleaning the air, captures the airborne dusts and particulates to separate the solid and liquid materials from the airflow, and on the other hand, kills the bacteria and micro microorganisms in the air sucked in by the blower wheel and sends out the sterilized air through the outlet grille. That is to say, the air purifier of the present invention cleans and sterilizes the air at the time. Thus, the present invention provides a delicate, effective and convenient sterilizing air purifier.

### BRIEF DESCRIPTION OF THE DRAWINGS

Other objects and advantages of the invention will be apparent from the following description taken with the accompanying drawings.

FIG. 1 is a perspective view of the air purifier of the present invention.

FIG. 2 is an exploded perspective view of the air purifier shown in FIG. 1.

FIG. 3 is a perspective view of an electric motor used in the air purifier shown in FIG. 1.

FIG. 4 is a perspective view of an airflow passage member used in the air purifier shown in FIG. 1.

FIG. 5 is a perspective view of a blower wheel used in the air purifier shown in FIG. 1.

FIG. 6 is an exploded perspective view of the air purifier shown in FIG. 1 made from another side.

FIG. 7 is a partial enlarged view showing the portion encircled by the circle of FIG. 6.

FIG. 8 is a side sectional view of the air purifier shown in FIG. 1.

### DETAILED DESCRIPTION OF THE PREFERRED EMBODIMENT

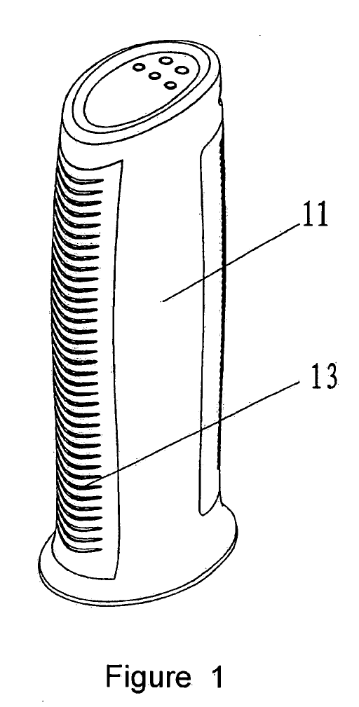

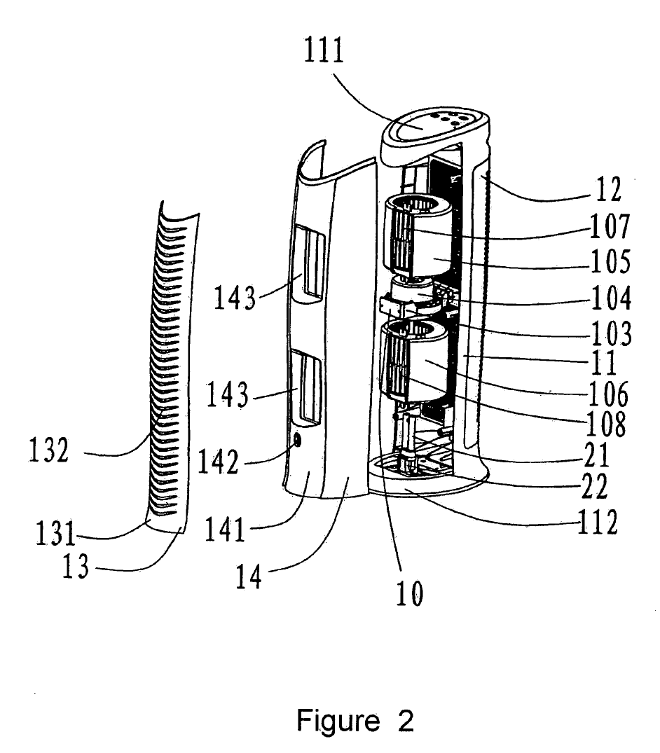

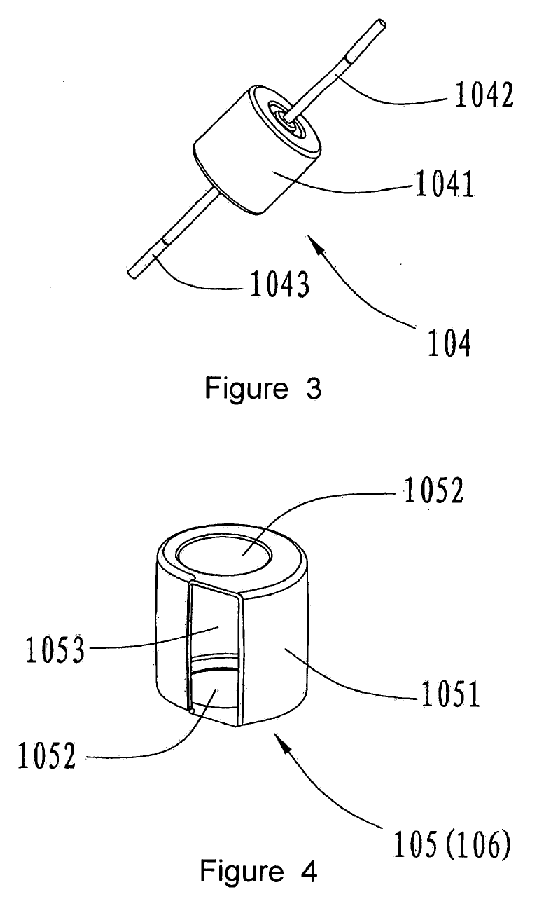

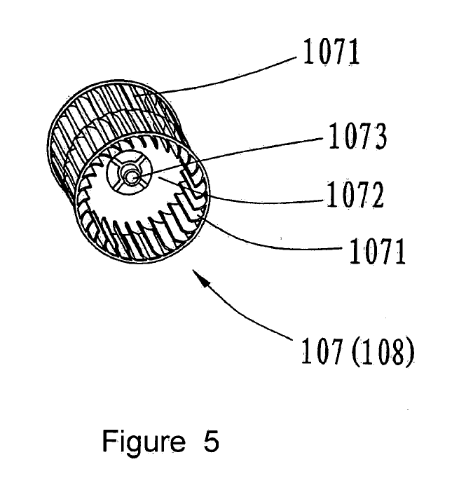

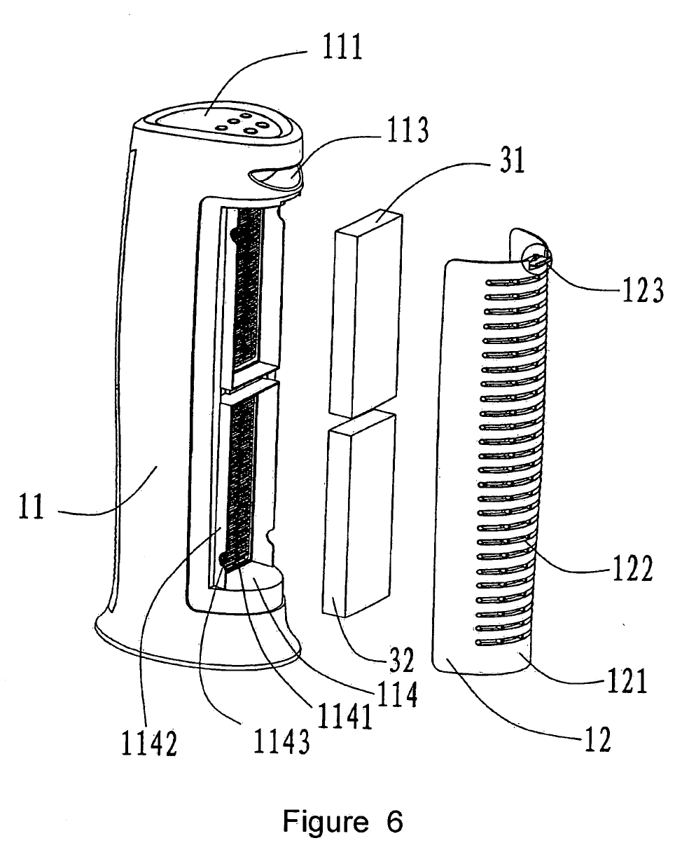

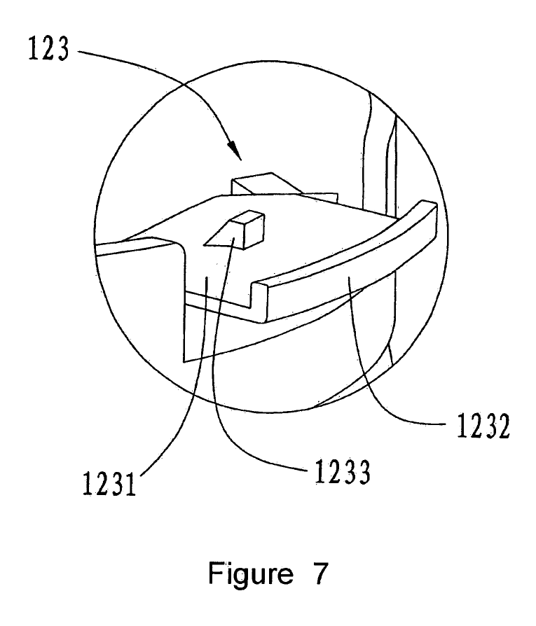

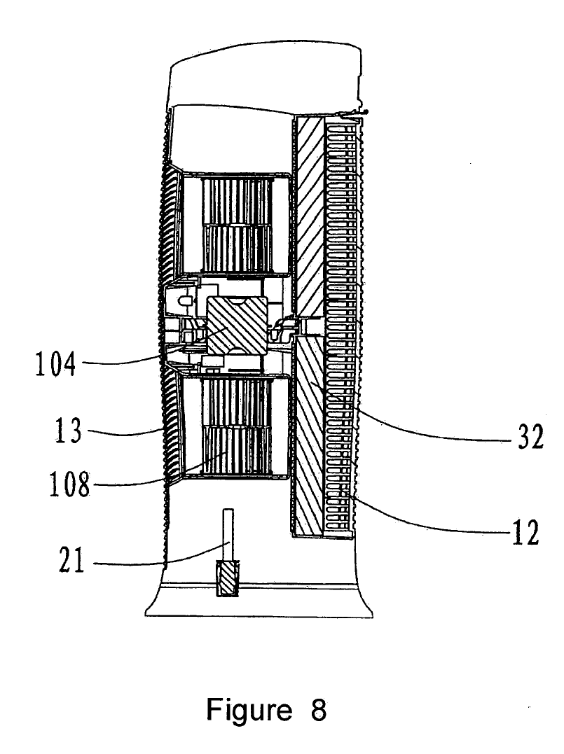

The air purifier of the present invention, as shown in FIGS. 1 to 8, comprises a vertically standing main frame 11, a front cover 14 provided with air outlets 143, an airflow generating device or blower assembly 10 installed inside the main frame 11, and a control panel 111 with buttons provided on the main frame 11. The main frame 11 has air inlets, and an inlet grille 12 is provided at a position corresponding to the air inlets. An outlet grille 13 is provided at a position corresponding to the air outlets of the front cover 14. The control panel 111 allows a use to control and adjust the operation of the air purifier. The main frame 11 is provided at its bottom portion with a base member 112 for supporting the whole purifier. The blower assembly 10 installed inside the main frame 11 comprises a double-shaft motor 104, an upper and a lower blower wheels 107 and 108 of double-entry penetrate-flow type, and an upper and a lower airflow passage members 105 and 106. The blower assembly 10 functions to suck in air from the interior or the main frame 11 and expel the air out through the outlet grille 13. For mounting the blower assembly 10 inside the main frame 11, a motor mount 103 is provided in the main frame 11, and the double-shaft motor 104 is mounted in the motor mount 103. The double-shaft motor 104 has a motor body 1041, and an upper and a lower shafts 1042 and 1043 extending out from the upper and lower ends of the motor body 1041 respectively. The upper and lower blower wheels 107 and 108 are mounted to the upper and lower shafts 1042 and 1043 respectively. The upper blower wheel 107 has a wheel body 1072, blade means 1071 extending from the wheel body 1072 to the opposite axial ends of the blower wheel, and a wheel mounting sleeve 1073 provided at the center of the wheel body and including a through hole. The through hole is to be inserted through by the upper shaft 1042 of the motor so as to fixedly mount the upper blower wheel 107 to the upper shaft via the wheel mounting sleeve 1073. The lower blower wheel 108, which has a structure similar to that of the upper blower wheel 107, is fixedly mounted to the lower shaft 1043 of the motor via its wheel mounting sleeve. The upper and lower airflow passage members 105 and 106 are fixedly mounted and surround the outer peripheries of the upper and lower blower wheels 107 and 108 respectively. The upper airflow passage member 105 has a passage body 1051 opened towards three directions. Specifically, the upper and lower ends of the passage body 1051 are each provided with a passage inlet 1052, and the sidewall of the passage body 1051 is provided with a passage outlet 1053. The lower airflow passage member 106 has a structure similar to that of the upper airflow passage member 105. When the upper and lower blower wheels 107 and 108 are rotating, air is sucked in from the passage inlets 1052 and is expelled out from the passage outlet 1053. A sterilizing device 20 provided inside the main frame 11 under the blower assembly 10 comprises an ultra-violet lamp 21 mounted on a lamp holder 22. The air within the main frame 11 is exposed to the ultra-violet light emitted from the ultra-violet lamp 21. The ultra-violet lamp 21 preferably emit out C-band ultra-violet light, more preferably, of a wavelength of about 254 nm. The ultra-violet light of such wavelength is capable of effectively killing bacteria and micro microorganisms, with a minimum ozone generation.

The front cover 14 has a vertically standing cover body 141 with a generally arc or semi-circle cross section shape. The front cover fits with the main frame 11 to form an integral housing structure surrounding the blower assembly 10 and the sterilizing device 20 therein. The cover body 141 is provided with a viewing aperture 142 provided with a transparent plastic sheet member. The sheet member has a thickness which meets the requirement of “UL certification” so as to prevent leakage of the ultra-violet light, while allows the used to check whether the ultra-violet lamp 21 operates properly by eyesight. The air outlets 143 of the front cover 14 are provided at locations above the viewing aperture 142 and directly opposing to the passage outlets 1053. The outlet grille 13 is provided in front of the front cover 14. The outlet grille 13 comprises an outlet grille body 131 of a generally streamline shape and being formed with a plurality of outlet apertures or slits 132. After the airflow is expelled from the air outlets 143, it passes through the outlet apertures 132 of the outlet grille 13 and comes out.

The inlet grille 12 has a vertically standing cover body 121 with a generally arc or semi-circle cross section shape and being formed with a plurality of inlet apertures or slits 122 through which the ambient air is sucked into the air purifier. The inlet grille 12 is provided with a snap locking means 123 at its top portion. The snap locking means 123 comprises an elastically deflection portion 1231 and a snap protrusion 1233 formed on the middle part of the deflection portion 1231. The deflection portion 1231 extends outwardly and is ended with a grasping portion 1232. When the inlet grille 12 is being mounted to the main frame 11, the snap protrusion 1233 engages into a corresponding part of the main frame 11, so as to fix the inlet grille 12 to the main frame 11. When the inlet grille 12 is to be detached, it simply need to push the grasping portion 1232 downwardly and then pull it outwardly. The side of the main frame 11 which fits with the inlet grille 12 is formed with two filter receiving compartments 114. Each of the filter receiving compartment comprises a holding grille 1141 which allows airflow to pass through, and sidewalls 1142 extending outwardly from the holding grille 1141 to form a filter receiving space for arranging a filter assembly 31 or 32 inside the filter receiving compartment 114. At least one of the sidewalls is formed with a notch 1143. When the filter assembly 31 or 32 received in the filter receiving compartment 114 is to be removed and replaced, a user can catch the filter assembly through the notch 1143 in a sidewall and take out the filter assembly. The filter assemblies 31 and 32 each are a combined structure of a pre-filter, a HEPA filter and an activated carbon filter. The pre-filter functions to filter out large airborne dusts, the HEPA filter filters out particulates of a size larger than 0.3 μm (micrometer), and the activated carbon filter absorbs the smell or odor in the air.

Now the operation of the air purifier of the present invention will be described. First, before start the operation, the filter assemblies 31 and 32 are inserted into the filter receiving compartments and the inlet grille 12 is snap fixed to the main frame 11. Then, the air purifier is activated by a user pressing the buttons on the control panel 111. The motor is started to rotate and thus blower assembly 10 begins to work to blow out the air inside the main frame through the outlet grille, whereby a negative pressure is generated in the main frame and thus the ambient air is sucked in through the inlet grille. As the air flows through the filter assemblies, the dusts and the particulates of a size larger than 0.3 μm are filtered out by the filter assemblies. The filtered air enters into the main frame and is exposed to the ultra-violet light emitted by the sterilizing device, so that the airborne bacteria and micro microorganisms. Then, clean air is conveyed by the blower assembly and is expelled out through the outlet grille 13. Thus, the air is cleaned twice by filtering and sterilizing. Further, the main frame is formed or provided with a handle portion 113, by which the air purifier of the present invention can be moved or handled easily.

1. An air purifier having sterilizing function, comprising a vertically standing main frame, a front cover provided with air outlets, a blower assembly installed inside the main frame, and a control panel provided on the main frame, wherein the main frame has air inlets, an inlet grille is provided at a position corresponding to the air inlets, and an outlet grille is provided at a position corresponding to the air outlets of the front cover, and wherein a sterilizing device is provided under the blower assembly.

2. The air purifier of claim 1 wherein the sterilizing device comprises an ultra-violet lamp emitting C-band ultra-violet light.

3. The air purifier of claim 1 wherein the blower assembly comprises a double-shaft motor, a double-entry penetrate-flow type blower wheel mounted to each shaft of the motor, and an airflow passage member being fixedly mounted and surrounding each of the blower wheels.

4. The air purifier of claim 3 wherein each blower wheel comprises a wheel body and blade means extending from the wheel body to the opposite axial ends of the blower wheel.

5. The air purifier of claim 4 wherein the blower wheels are similar to each other in structure and each comprises a wheel mounting sleeve provided at the center of the wheel body and including a through hole, and each blower wheel is fixedly mounted to a corresponding shaft of the motor by means of its wheel mounting sleeve.

6. The air purifier of claim 1 wherein the inlet grille is provided with a snap locking means at its top portion, the snap locking means comprises an elastically deflection portion and a snap protrusion formed on the middle part of the deflection portion, and the inlet grille is snap engage with the main frame by the snap protrusion.

7. The air purifier of claim 4 wherein the deflection portion extends outwardly and is ended with a grasping portion, the grasping portion being pushed when detaching the inlet grille.

8. The air purifier of claim 7 wherein the side of the main frame which fits with the inlet grille is formed with two filter receiving compartments each containing a filter assembly, and each of the filter assemblies comprises a pre-filter, a HEPA filter and an activated carbon filter.

9. The air purifier of claim 8 wherein each of the filter receiving compartment comprises a holding grille which allows airflow to pass through, and sidewalls extending outwardly from the holding grille to form a filter receiving space for arranging a filter assembly, at least one of the sidewalls is formed with a notch for facilitating the detach of the filter assembly.

10. The air purifier of claim 8 wherein the main frame comprises a handle portion.

11. The air purifier of claim 2 wherein the inlet grille is provided with a snap locking means at its top portion, the snap locking means comprises an elastically deflection portion and a snap protrusion formed on the middle part of the deflection portion, and the inlet grille is snap engage with the main frame by the snap protrusion.

12. The air purifier of claim 3 wherein the inlet grille is provided with a snap locking means at its top portion, the snap locking means comprises an elastically deflection portion and a snap protrusion formed on the middle part of the deflection portion, and the inlet grille is snap engage with the main frame by the snap protrusion.

13. The air purifier of claim 4 wherein the inlet grille is provided with a snap locking means at its top portion, the snap locking means comprises an elastically deflection portion and a snap protrusion formed on the middle part of the deflection portion, and the inlet grille is snap engage with the main frame by the snap protrusion.

14. The air purifier of claim 5 wherein the inlet grille is provided with a snap locking means at its top portion, the snap locking means comprises an elastically deflection portion and a snap protrusion formed on the middle part of the deflection portion, and the inlet grille is snap engage with the main frame by the snap protrusion.
